(19) United States
(12) Patent Application Publication
(10) Pub. No.: US 2023/0267760 A1
(43) Pub. Date: Aug. 24, 2023

(54) BIOMETRIC AUTHENTICATION SYSTEM

(71) Applicant: EVATEC AG, Trübbach (CH)

(72) Inventor: Silvia SCHWYN THÖNY, Wangs (CH)

(21) Appl. No.: 18/005,241

(22) PCT Filed: Jun. 21, 2021
(86) PCT No.: PCT/EP2021/066785

§ 371 Date: Jan. 12, 2023

(30) Foreign Application Priority Data
Jul. 17, 2020 (CH) 00887/20

(51) Int. Cl. G06V 40/13; G06V 40/12; G06F 3/042; G02B 5/26; G02B 5/28; H01B 3/10

(52) U.S. Cl. CPC G06V 40/1318; G06V 40/1329; G06V 40/1365; G06F 3/0421; G02B 5/26; G02B 5/282; H01B 3/10

(57) ABSTRACT

A biometric authentication system including:
a translucent protective plate having an authentication region on a front face of the protective plate, and a reverse side forming the second face of the plate, essentially in parallel to the front face;
a light emitting source to illuminate an object pressed against or being in touch with the authentication region;
a sensor arranged at the reverse side or in a distance from the reverse side;
an optical path from the authentication region to the sensor;
an optical filter within the optical path;
   whereat the optical filter is a layered near infrared (NIR) filter including:
at least one of an inner ZnOₓ and/or inner TiOₓ layer at a substrate side;
followed by a multitude of silver layers, each silver layer being separated from each neighboring silver layer by at least one of a further ZnOₓ and/or a further TiOₓ layer;
at least one of an outer ZnOₓ layer, an outer TiOₓ layer, and/or a blocking layer deposited on the outermost silver layer.

The invention refers to a biometric authentication system, according to claim 1, a touch screen according to claim 19 and an electronic device according to claim 20.

### TECHNICAL BACKGROUND

Today, biometric authentication systems as face recognition or fingerprint identification systems are integrated in a broad range of electronic devices like cell phones, touch pads, computers or any other input/output devices.

Capacitive systems analyzing a more or less two-dimensional surface of a three-dimensional object pressed against or being in touch with the surface of an authentication region have been in use for fingerprint sensors since long. These systems however tend to fail when contact pressure is too low and cannot be integrated directly into the surface of a touchscreen without reducing the display area of the front side. Only recently also optical fingerprint identification systems have been introduced to the markets which have been integrated into full front displays of hand-held devices. Despite of certain improvements which could be achieved also with detection reliability there are still issues with contact pressure, all the more when it comes to new detection issues like counterfeit protection by distinction of living and dead material, which could be shown recently to be feasible by analyses of two different wavelength, e.g. blue, green, yellow, or orange, within the visible light spectrum. For all of these issues however, elimination of disturbing background NIR-illumination coming from the outside or from the display illumination itself is crucial when it comes to analyze reflected signals of a certain wavelength or in a certain wavelength range. Dielectric filters for the NIR-range as used today tend to have a complicated thick multilayer design reaching several micrometers of thickness being not only expensive but may also rise adhesion problems due to layer tension. Additionally, such filters tend to have a strong dependency of the filter characteristic from the incident angle of the light, which limits analyzing regions essentially or makes additional efforts to align the optical path before it reaches the sensor. It should be mentioned that NIR according to the usual definition comprises a wavelength range from 780 nm to 3 μm including the spectral range of IR-A and IR-B. However, filters as used with biometric authentication systems, especially with fingerprint systems may or should also block visible red light in the range from 640 nm to 780 nm or at least the far red range of it, to optimize signal processing in the blue, green, yellow or orange range.

### SUMMARY OF THE INVENTION

It is therefore an issue of the present invention to improve the performance of optical biometric authentication systems to analyze a more or less two-dimensional surface as mentioned above. Improvements should be realized in detection reliability, accuracy of the analyzed wavelength region and/or cost of ownership.

A biometric authentication system according to the present invention comprises at least:
a translucent protective plate, which can be of glass or sapphire, having an authentication region on a front face of the protective plate; a reverse side forming the second face of the plate, essentially in parallel to the front face;
a light emitting source to illuminate an object pressed against or being in touch with the authentication region;
a sensor arranged at the reverse side or in a distance from the reverse side behind the plate, the distance of the sensor to the front face being longer than the distance from the reverse side of the plate to the front face;
an optical path from the authentication region to the sensor to guide light from the light emitting source which is reflected by the object in touch with the authentication region to the sensor whereby the object may be a finger and the authentication region may be fingerprint region;
an optical filter within the optical path.

The optical filter is a layered near infrared (NIR) filter consisting of
at least one of an inner ZnOₓ and/or an inner TiO_{X}layer 1 at a substrate S side which may comprise also a seed layer 1′, that is the innermost layer deposited directly on the surface of the substrate S; the inner ZnOₓ and the inner TiOₓ layer are also referred to as inner metal oxide layer(s);
followed by a multitude of silver layers 2, 4, each silver layer 2 being separated from each neighbouring silver layer 4 by at least one of a further ZnOₓ layer 3 and/or a further TiOₓ layer 3; the further ZnOₓ and the further TiOₓ layer are also referred to as further metal oxide layer(s);
at least one of an outer ZnOₓ layer 5, an outer TiOₓlayer 5, and/or an oxygen blocking layer 6 deposited directly or alternatingly on the outermost silver layer 4; the outer ZnOₓ and the outer TiOₓ layer are also referred to as outer metal oxide layer(s).

The minimum layer stack may end with an outermost blocking layer, in this case the blocking layer constitutes the layer furthermost from the substrate surface.

Alternatively, the layer stack may have a dielectric layer stack provided on the outer surface of the blocking layer.

The blocking layer may consist of at least one of TiOₓ, ZnOₓ, SnOₓ, CryOₓ and/or NiCrOₓ. In general, with layer-filters as described above bandwidth filters of different width can be produced in a band-range from about 400 nm to about 1650 nm. For biometric authentication like fingerprint recognition systems however a transparency bandwidth from about 400 nm to 650 nm would be most convenient. In certain cases also a smaller bandwidth e.g. from 400 nm to 600 nm might be preferably. Further embodiments to optimize certain filter parameters are described in the following. A metal interface layer consisting of a metal corresponding to a respective metal of a metal oxide layer may be provided between at least one neighbouring silver layer, which can be a preceding and/or a next silver layer, to avoid any oxidation of the sensible silver surface. The metal interface layer being in direct contact to both the neighbouring silver and the respective metal oxide layer. Metal oxide layers as mentioned above may comprise also substoichiometric regions or sublayers, at least at the silver side(s) of the metal oxide layers whereas other regions or sublayers may be stoichiometric or nearly stoichiometric. That means the metal-oxide layer side(s) directly in contact with the silver or the interface layer may be substoichiometric from about 5% to 50% of the stoichiometric value, e.g. TiO_{1.0-1.9}, ZnO_{0.5-0.95}, SnO_{1.0-1.9}.

Alternatively layers can be gradient-like or graduated, e.g. from the metal interface layer at the silver contact face to a substoichiometric, a near stoichiometric, or even a stoichiometric composition, e.g. at the substrate side of the inner ZnOₓ or inner TiOₓ layer, in the middle of the further ZnOₓ and/or TiOₓ layers, or at the outer side of the outer ZnOₓ and/or outer TiOₓ layer. The same refers to other elements of the blocking layer as referred above when the blocking layer should replace the outer ZnOₓ or outer TiOₓ layer.

The at least one ZnOₓ layer may be an aluminum doped ZnOₓ:Al (AZO) layer which may have an atomic Al/Zn ratio r _{Zn/Al} from 90 to 99%, e.g. about 5% Al. Alternatively the at least one ZnOₓ layer may be a galium doped ZnOₓ:Gal (GaZO) layer which may have an atomic Ga/Zn ratio r Zₙ/Gₐ from 90 to 99%, e.g. about 5% Ga.

In a further embodiment of the invention the NIR-filter may comprise an AR-stack consisting of alternating high and low refractive layers which is deposited on one of the outer ZnOₓ layer, the outer TiOₓ layer, or the blocking layer whereby antireflective (AR) properties of the filter can be optimized and sharp filter edges can be realized. To yield respective AR-properties the AR-stack should consist of at least four layers but may have essentially more, e.g. from 16 to 32 layers.

In a further embodiment a metallic or semi-conductive seed layer, which may consist of metals like Zn, Ti, Cr, or semiconductors like Si, may be provided at the substrate surface.

A further AR-stack which may also have ultraviolet (UV) light damping or blocking properties can be arranged as a stack of alternating high and low refractive layers between the substrate and the metallic or semi-metallic seed layer and the inner metal oxide (ZnOₓ or TiOₓ) layer. The further AR-stack may comprise at least 2 alternating layers of high and low index materials. A number between two and four layers will be usually suffice. In a further embodiment a SiO₂ layer, or a stack of alternating SiO₂ and Ta₂03 layers can be sandwiched between two ZnOₓ layers, or an inner TiO₂ layer and an outer ZnOₓlayer, whereat the ZnOₓ layers or the inner TiO₂ layer and the outer ZnOₓ layer are adjacent to a silver layer with their side facing away from the sandwiched layer(s).

Respective ZnOₓ layers can comprise or consist of AZO or GaZO layers. Alternatively, the sandwiched stack can consist of any combination of low index material like SiO₂ and high index materials, such as TiO₂, Nb₂O₅, HfO₂, ZrO₂ or Si₃N₄. Only a substoichiometric oxide and/or a titanium, a Zn or an aluminum doped zinc (Zn:Al) layer may be provided between the respective sandwiching oxide layer and the silver layer in analogy to the layer sequence Ag/metal (Zn, Zn:Al or Ti)/substoichiometric oxide (of Zn, Zn:Al or Ti)/near or even stoichiometric oxide (of Zn, Zn:Al or Ti), or can be gradient-like or graduated as described above.

In one embodiment the light emitting source can be a planar light source arranged below the authentication region, e.g. in a vertical direction from the front face of the cover plate. The arrangement can be within the protective plate, e.g. with split cover plates, on the backside of the protective plate or in a distance from and facing the reverse side of the cover plate. The planar light source can be an OLED array or a part of an OLED array, e.g. the OLED array of a respective device, situated within or near the optical path of the biometric authentication system.

In a further embodiment the light emitting source can be a separate light source arranged below the authentication region on or in a distance from the reverse side of the cover plate. This can be in a vertical direction from the authentication region or oblique, in an angle to the authentication region.

The optical path of the system may comprise a lens or a mirror to focus the reflected light to the sensor. Alternatively, the optical path may comprise a collimator.

The invention is further directed to an electronic device comprising a touch screen and a system as described above. The device can be a cell phone, a touch pad, a computer, or any other input/output device, like geographic positioning systems (GPS), geodetic or other measurement systems and the like.

It should be mentioned that all features as shown or discussed in connection with only one of the embodiments of the present invention and not further discussed with other embodiments can be seen to be features well adapted to improve the performance of other embodiments of the present invention too, as long such a combination cannot be immediately recognized as being prima facie inexpedient for the man of art. Therefore, with the exception as mentioned all combinations of features of certain embodiments can be combined with other embodiments where such features are not mentioned explicitly.

### FIGURES

The invention shall now be further exemplified with the help of figures. It should be mentioned that the figures are merely drawn to demonstrate the function of one or usually several embodiments of the invention without showing scaled dimensions or proper proportions of certain components to make the principals of the invention easier to see. The figures show:

FIG. 1: fingerprint identification system, FID I;

FIG. 2: fingerprint identification system, FID II;

FIG. 3: detail of system II;

FIG. 4 to 7: principles of filters for an inventive FID system;

FIG. 8 to 10: state of the art filters for FID systems;

FIG. 11 to 15: optical properties of filters used with inventive FID systems.

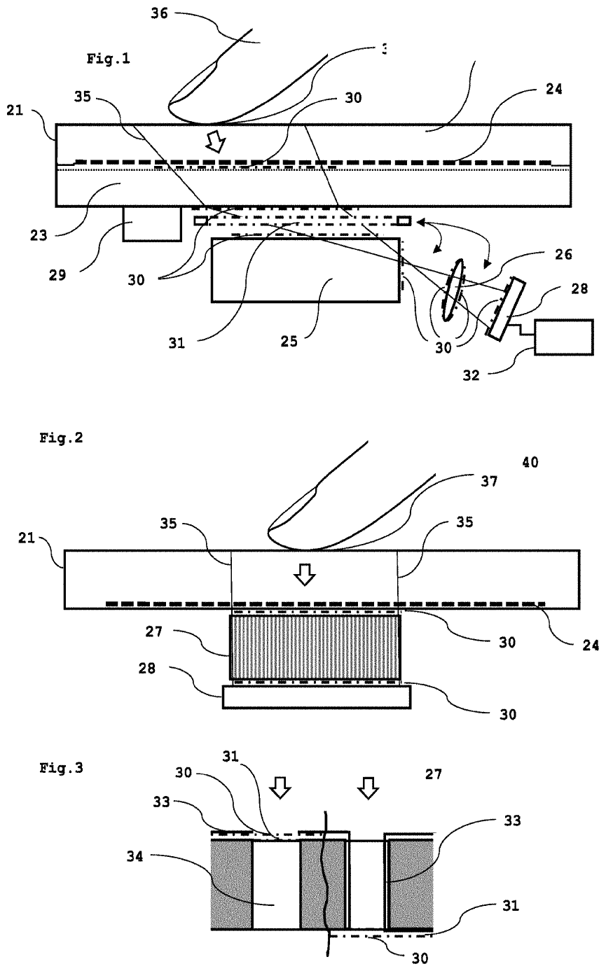

FIG. 1 shows variations of a first embodiment of a fingerprint identification system 20, comprising a split cover plate 21 having a front plate 22 with a fingerprint area 37 to be touched by the users finger 36 and a backplate 23 to fix the LED array 24 on the back of the front plate 22 and to have further components like e.g. a further light source 29, an NIR filter 31 or a transparent spacer 25 having a low refractive index (RI) attached on the reverse side of the backplate 23, which here also forms the reverse side of the cover plate 21. A finger 36 in touch with the fingerprint area 37 of the cover plate 21 is illuminated by at least some LEDs of the LED-array 24, the separate light source 29, or both together. An optical path of the light reflected by the fingerprint is defined by its boundaries 35, the reflected light being symbolized by an arrow departing from the fingerprint area 37. Having past the cover plate 21 and the spacer 25 the light in the optical path is focused by an optional lens 26, which can be a micro-lens, to the sensor 28, which can as an example be a photo-chip. The sensor 28 is connected with a controller unit 28, which can be the CPU of an electronic device comprising the optical fingerprint identification system, e.g. within a touch screen, or can have a separate controller connected to the circuitry of the device (not shown). Within the optical path the reflected light as well as potential interfering light from the exterior or the LED-array can be filtered by a filter stack 30 which can be deposited on various surfaces which may also form optical interfaces within the boundaries 35 of the optical path between the fingerprint area 37 and the sensor 28. In an alternative embodiment, additionally shown in FIG. 1 a separate filter 31 can be used comprising such an NIR-filter stack on a separate glass.

It should be noted that with FIG. 2, FIG. 3 and especially with FIG. 1 a multitude of several possible positions to place the filter stack 30 or the separate filter 31 in the optical path is shown to demonstrate different varieties of the system. One filter stack 30, or one separate filter 31 in any of those positions will suffice to filter NIR or other wavelength which might interfere with the green-blue-yellow spectrum most adapted to resolve the fine structures of a fingerprint. As can be seen with FIG. 1 the filter stack 30 symbolized by dash-dotted lines can be provided on the backside of the LED-array, on the front face, or the reverse side of the back plate 23, on any side of the transparent spacer 25 within the optical path, on a side of the lens 26 or on the front side of the sensor array 28. Alternatively, a separate filter 31 can be used between the cover plate 21 and the spacer 25, and as symbolized by two double arrows between the spacer and the lens, or between the lens 26 and the sensor 28. The filter can be a usual glass-plate provided with a respective filter stack on one of its surfaces. When using a mirror/sensor system (not shown) instead of a lens/sensor system, a filter stack may be also provided on the surface of the mirror.

FIG. 2 shows variations of a further embodiment with a one-piece cover plate 21 and an LED array 24 integrated on the reverse side showing two alternative positions for an NIR-filter stack 30. One position is again on the reverse side of the cover plate 21, in this case on the surface of an LED-array block, the other position again on the front side of the sensor array 28. A collimator 27, a pinhole array, or alternatively an optical waveguide can be used to guide the light from the cover plate 21 to the sensor 28. It should be mentioned that, as also shown by the same reference number, split and one-piece cover plates 21 from FIGS. 1 and 2A can be exchanged between the two alternative systems when designed to have the same optical properties.

Usually it would be expedient to apply filter stacks 30 deposited directly on a system component instead of using a separate filter. However such optical filters 31, due to their smaller dimension compared e.g. to the cover plate of a display, and the lack of potential sensitive electronic components as would be with a sensor, might be more efficient and cost effective to produce, especially when it comes to deposit highly sophisticated layer stacks of different materials in an expensive and volume-limited multi-chamber PVD-equipment.

In FIG. 3, which is a magnification of a section of the collimator 27 of FIG. 2, the use of a Filter 31 comprising an NIR-stack 30 at least at one of its surfaces is shown at two different positions of the collimator. On the left side the NIR-filter 31 is mounted on the side of the incident light and comprises a black coating 33 deposited here on the NIR-filter stack in areas covering the structure of the collimator shown with a grey background. Therewith optical resolution of reflected light coming from different regions of the fingerprint area 37 can be improved.

On the right side of FIG. 3 the filter 31 is mounted on the opposite side where the light leaves from the collimator 27 towards the sensor 28. In this embodiment the collimator is coated on the front side and within the through holes 34 with a black coating 33 which gives an even better light separation than with the structure as shown on the left side, however needs the coating of two different components as an additional cost issue in mass-production.

With reference to the complexity of the systems due to the necessity of focusing or aligning the reflected light as shown in FIG. 1 to 3, it should be mentioned that optical specifications of certain elements like spacer 25 or lenses 26 of the system according to the first embodiment or the collimator 27 with the second embodiment can be reduced, or such elements can be even omitted due to the better optical characteristic of the silver zinc oxide (titanium oxide) filters as used with the present invention. Therefore, with FIG. 1, lens 30 and/or spacer 25 could be omitted when such layer-filter is applied to the backside of the LED-array, on the front face, or the reverse side of the back plate 23, on the front side of the sensor array 28, or alternatively, a separate filter 31 is used between the cover plate 21 and the sensor 28. With FIG. 2 collimator 27 could be omitted when a layer-filter is used on the backside of the cover plate 21 or on the front side of the sensor 28, or a separate filter 31 in between as mentioned above.

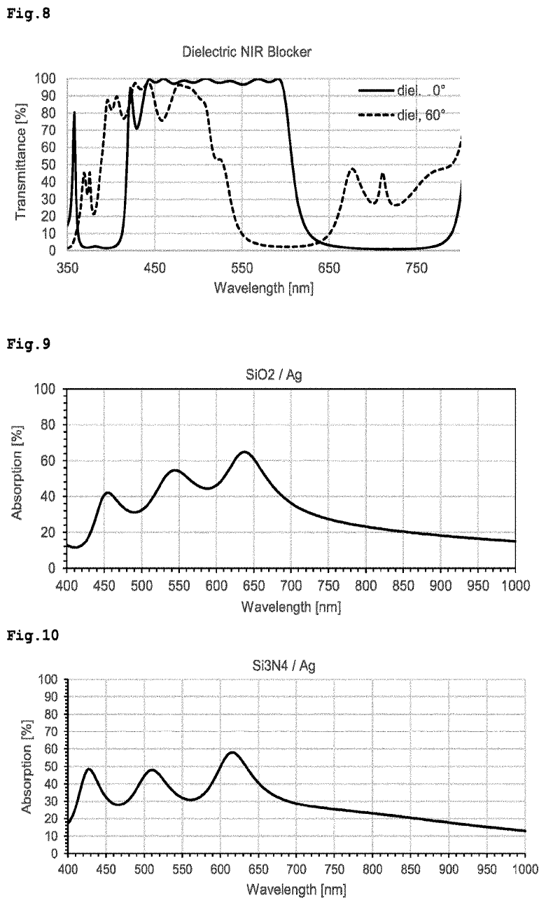

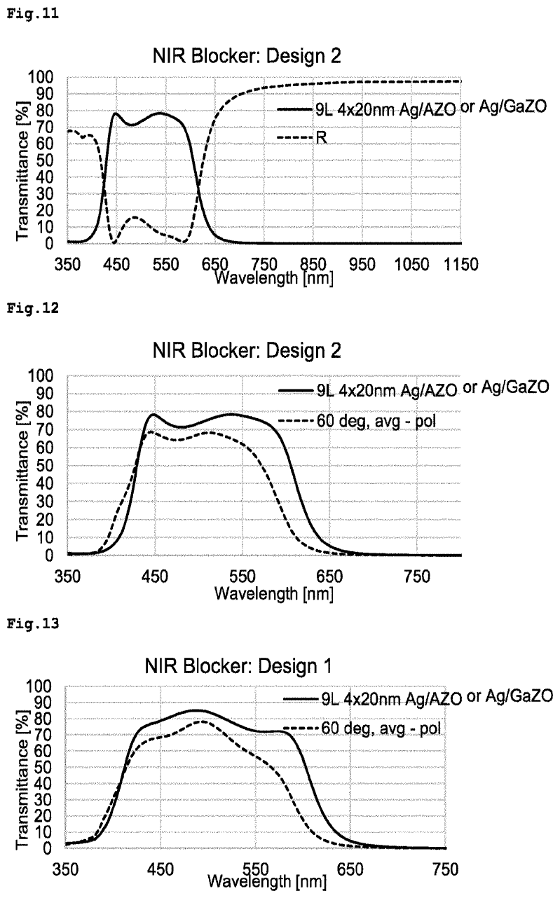

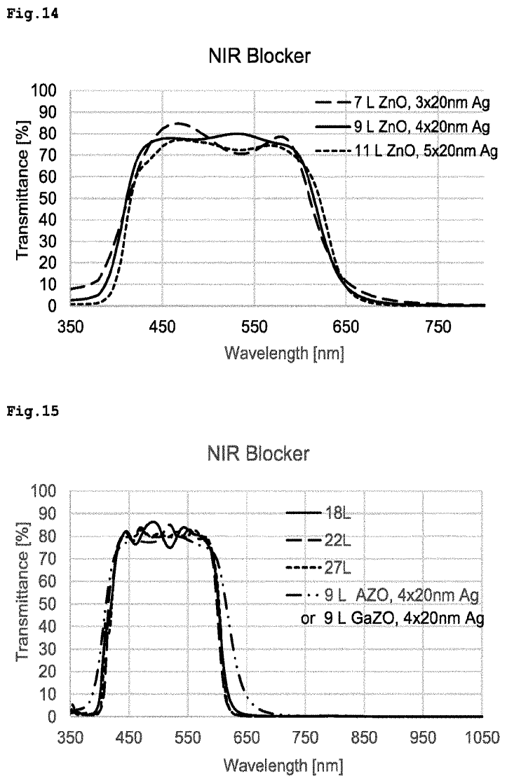

This characteristic does not comprise higher transmittance and steeper and more defined filter edges only, see FIG. 11 to 12,14,15 but also an essentially reduced shift of the NIR-filter edge with reference to different angles of the incident light, see FIGS. 12 and 13 compared to FIG. 8 of a state of the art design.

Extensive experiments with pure dielectric stacks as preferably used for filters in the optics and photonics industries did not yield an essential improvement. As can be seen with FIG. 8, such dielectric filters show excellent transparency within the bandwidth gap and respective similar good acutance on both sides of it when analyzed with a 0° angle of incidence. It should be mentioned that a zero degree angle here refers to the standard measurement angle which is vertical to the substrate plane and any deviation is given with respect to the so called surface normal in accordance with usual technical language. However, when using a 60° angle (dashed line) the picture with the dielectric filter is very different. Transparency shows severe fluctuance within the bandwidth gap, edges show a loss of acutance and worst of all, the decisive upper filter-edge shows a shift of 77 nm from 609-532 nm which is a relative shift of about 13% and therewith out of any range for biometric applications which have to operate with light of different incident angles. Layer design of such a state of the art dielectric filter stack can be found with table 1. It consists of a sequence of alternating TiO₂/SiO₂λ/n-layers having a total layer thickness of about 1.5 μm.

Many material combinations have been tested also with mixed di-electric and silver stacks and have been analyzed with reference to their optical performance. However, absorption curves of SiO₂/Ag and Si₃N₄/Ag layers as shown in FIG. 9 and FIG. 10 do not look very promising. Layer sequences of the respective coatings can be seen in table 2 and table 3.

However, surprisingly by use of a combination of metal oxide layers from ZnOₓ, AZO, GaZO and/or TiOₓ and silver layers tailored NIR-filter stacks having high transmission in the visible light band and good blocking properties for NIR-filters could be produced. At the same time UV-blocking properties are good enough to block harmful radiation from about 400 nm or lower wavelength. Due to the thin thickness of about one micrometer or even less, such coatings can be perfectly used with microelectronics components. Additional AR- and UV-blocking properties or higher transparency in the bandwidth gap and better edge acutance could be added by use of dielectric stacks 11 which can be also arranged directly on the substrate S or seed layer 1′ as a further dielectric stack 13, be sandwiched between further ZnOₓlayer(s) and/or a further TiO_{X} layer, e.g. stack 14, and/or be placed on top of the basic NIR blocking stack 12.

Some principles on such coating set-ups are shown in FIG. 4 to FIG. 7. Realized examples and set-ups are shown in tables 4 to 6 and in FIG. 9 to FIG. 15. FIG. 4 to FIG. 7 show in an exemplary manner different set ups of a stack comprising an NIR-blocking stack 12 comprising at least two silver layers 2,4 separated by a ZnOₓ layer 3,5 which can be an AZO layer.

In detail the optical filter is a layered near infrared (NIR) filter consisting of
at least one of an inner ZnOₓ 1 and/or an inner TiOₓlayer 1 at a substrate S side which may comprise also a seed layer 1′, that is the innermost layer deposited directly on the surface of the substrate S;
followed by a multitude of silver layers 2, 4, each silver layer 2 being separated from each neighbouring silver layer 4 by at least one of a further ZnOₓ layer 3 and/or a further TiO_{X} layer 3;
at least one of an outer ZnOₓ layer 5, an outer TiOₓlayer 5, and/or an oxygen blocking layer 6 deposited directly or alternatingly on the outermost silver layer 4.

It should be mentioned that blocking stack 12 shows two silver 2,4 and respective ZnOₓ layers 1,3,5 only for reasons of clearness, whereas filters from 2 to 6 silver layers, especially from 3 to 5 silver layers can be used to optimize the respective filter designs, see e.g. FIG. 11 to 15.

With reference to the inner further or outer TiOₓ layers, the latter may be also a blocking layer, good optical properties could be reached when alternating TiOₓ/ZnOₓ/Ag/TiOₓ/ZnOₓ/Ag layers where used as exemplarily shown in table 5.

The minimum layer stack ends with the outermost blocking layer 6. In this case the layer furthermost from the substrate, which may consist of at least one of TiO_{X}, ZnOₓ, SnOₓ, CryOₓ and/or NiCrOₓ. The blocking layer 6 can be used on top of outer metal oxide layer 5 as shown or may replace the outer metal oxide layer 5.

With reference to the deposition of the layer stack which can be performed e.g. by sputtering, it should be mentioned that it is important to provide as an interface a metallic layer of one or a few nanometers at each side of the silver layer 2, 4 to avoid any oxidation of the silver surface which would influence optical properties like reflexivity of the silver layer. Such metallic interface layers are illustrated in dotted lines in FIG. 6 and may consist of Ti, Zn, Sn, Cr, NiCr, depending on the respective neighbouring metal oxide layer 1, 3, 5 or 6 which may consist of TiOₓ, ZnO_{X}, SnO_{X}, Cr_{y}OX or NiCrOₓ as mentioned above. Therewith metal-oxide layers can comprise substoichiometric regions or sublayers 1″, 3″, at least at the silver side(s) of the metal oxide layers 1, 3, 5, 6 whereas other regions or sublayers 1′, 3′ may be stoichiometric or nearly stoichiometric.

In a further embodiment of the invention the NIR-filter may comprise a dielectric stack 11 consisting of alternating high and low refractive layers deposited on one of the following layers: the outer ZnOₓ layer, the outer TiOₓlayer, or the blocking layer whereby antireflective (AR) properties of the filter can be optimized and sharp filter edges can be realized. This stack will consist of at least four layers however may have essentially more.

Further tuning or improving optical properties of the filter may comprise an embodiment of the invention having a SiO₂ layer, which is a low index material layer, or a stack 14 of alternating SiO₂ and at least one high index layer consisting of high index material sandwiched between two further metal oxide layers, whereat each of the two further metal oxide layers is in direct contact to a or to the SiO₂ layer, and is adjacent to a respective silver layer with its side facing away from the sandwiched SiO₂ layer(s). The high index material may consist of Ta₂O₅, TiO₂, Nb₂O₅, HfO₂, ZrO₂ or Si₃N₄ and the sandwiched stack may be a three layer stack consisting of two SiO₂ layers and a high index layer again sandwiched between the two SiO₂ layers.

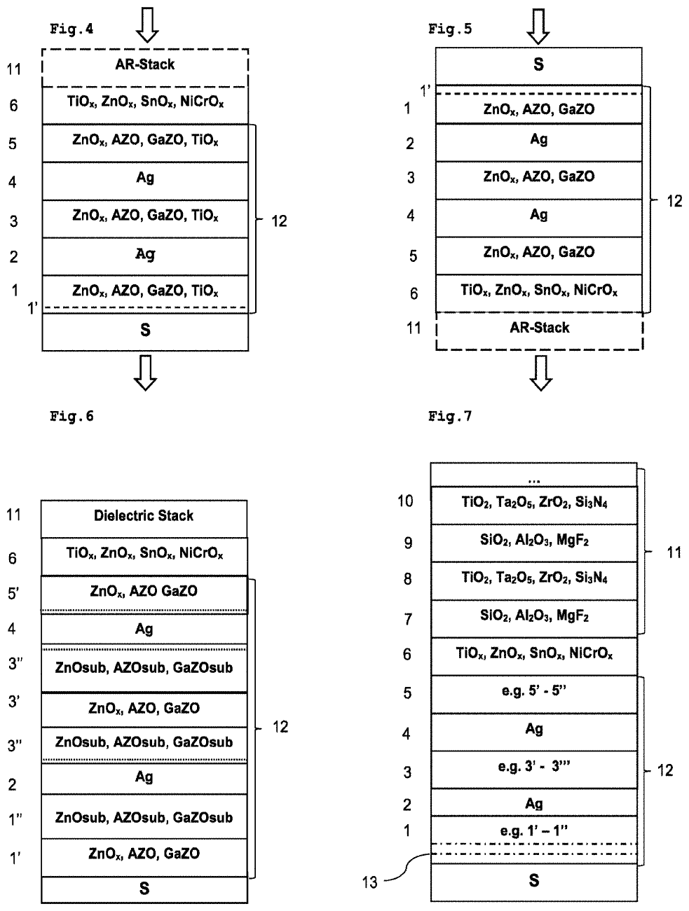

FIGS. 4, 6 and 7 show substrates having respective layer stack(s) provided at the side of the incident light, whereas FIG. 5 shows a substrate having the layer stack(s) at the side where the light, symbolized by arrows in FIGS. 4 and 5, leaves the component on the optical path towards the sensor. With the exception of an optional seed layer 1′, which has to be provided at the substrate surface, e.g. to improve adhesion, the layer sequence can be the same with reference to the substrate surface, which in this case is inverse with reference to the light direction, due to the additive nature of the optical layer properties.

With FIG. 7 material combinations for low refractive materials, like SiO₂, Al₂O₃, or MgF₂, and of high refractive materials, like TiO₂, Ta₂O₅, or ZrO₂, Si₃N₄, are given. A further AR-stack 13 is shown which can be provided directly on the substrate S or seed layer 1′ to enforce AR properties of AR-stack 11. Additional UV-damping or UV-blocking effects may be added by further AR-stack 13 too.

Examples of a respective NIR-filter stacks are given in tables 4 to 7 and FIG. 11 to 15, wherein table: Table 4 refers to FIGS. 11 and 12 showing the optical properties of coating design 2, and to FIG. 13 showing respective properties of design 1;

Both designs are relatively simple NIR-filters consisting of four alternating AZO or GaZO/Ag layers completed with an outer AZO or GaZO layer, having a physical layer thickness between 50 and 200 nm, which is thin. The only relevant difference is the physical thickness of certain AZO or GaZO layers, especially of the inner AZO or GaZO layer nearest to the substrate, which is thicker with design 2. Therewith in comparison of FIGS. 12 and 13 a slightly better transparency of the thinner design 1 results in a wavelength range between 450 to 500 nm, whereas design 2 shows a better uniformity in the transparent region and filter edges being better defined on both sides. Additional to a 0° measurement, a measurement using light in an angle of 60° to the surface normal of the two test samples has been taken. The results at half width of the maximum were for design 1 (FIG. 13) 0°->60° : 608->581 nm or 4.8%; for design 2 (FIG. 12) 0°->60° : 614->586 nm or 4.6%;

As can be seen a shift of the NIR edge of smaller 30 nm which is smaller than 5% could be reached in case of both designs, whereas the shift of the UV-edge was nearly neglectable. Design 2 again yielded a better uniformity. In view of the considerable different angle of the 60° measurement this minor change seems to be quite satisfying.

FIG. 11, in addition to the transparency of design 2 also shows the respective absorption R in comparison.

All photospectrometric measurements have been taken with a PhotonRT spectrometer by Essen-Optics. Optical samples have been deposited on a 200 mm glass of the D263-type in a commercial CLN 200 BPM-equipment from Evatec AG, Switzerland. Examples of the process parameters as used can be found in table 8. The same equipment and comparable process parameters have been used to produce respective filters on various components in the optical path as described above.

Table 5 refers to coating design 3 comprising an alternating TiOₓ/ZnOₓ/Ag/TiOₓ/ZnOₓ/Ag . . . layer not shown in the figures.

Table 6 refers to design 4 to 7, all in a medium thickness range between about 200 and 1000 nm, where optical transmittance of designs 5 to 7 is shown in FIG. 14.

Medium NIR-filters as shown in FIG. 14 give a good survey how edges and uniformity can be influenced with filters having three (design 5), four (design 6), and five (design 7) silver layers, each of about 20 nm thickness.

Table 7 refers to designs 10 to 12, all in a thick thickness range between about 1000 and 2500 nm, where optical transmittance of designs 5, 10, 11 and 12 is shown in FIG. 15. Additional layer thickness here comes primarily from the AR-stack, in this case an alternating Ta₂O₅/SiO₂ stack, and in part of a single further AR-stack, consisting of a Ta₂O₅-layer, directly deposited on the substrate and a consecutive SiO₂-layer on top of the NIR-filter. As can be seen with FIG. 15 transmission and steepness of the filter edge could be further improved with reference to the medium thickness design 5. Similar results could be achieved with comparable other high/low-index combinations like TiO₂/SiO2, TiO₂/Al₂O₃, or else as mentioned above.

For many biometric authentication systems, especially fingerprint identification systems, less sophisticated designs in the middle or even low thickness range will suffice to analyze the pattern produced by the object, e.g. the fingerprint, with good resolution.

Finally, it should be mentioned that a combination of features mentioned with one embodiment, examples or types of the present invention can be combined with any other embodiment, example or type of the invention unless being obviously in contradiction.

TABLE 1
Dielectric NIR blocker

| | | Design |
|---|---|---|
| | | TiO2/SiO2 |
| Layer | Material | d phy |
| Substrate | Glass | [nm] |
| 1 | TiO2 | 113.0 |
| 2 | SiO2 | 199.3 |
| 3 | TiO2 | 27.3 |
| 4 | SiO2 | 194.5 |
| 5 | TiO2 | 39.079 |
| 6 | SiO2 | 174.594 |
| 7 | TiO2 | 46.325 |
| 8 | SiO2 | 182.919 |
| 9 | TiO2 | 22.295 |
| 10 | SiO2 | 118.103 |
| 11 | TiO2 | 90.460 |
| 12 | SiO2 | 100.307 |
| 13 | TiO2 | 79.260 |
| 14 | SiO2 | 132.583 |
| 15 | TiO2 | 54.900 |
| 16 | SiO2 | 146.308 |
| 17 | TiO2 | 62.980 |
| 18 | SiO2 | 133.970 |
| 19 | TiO2 | 75.102 |
| 20 | SiO2 | 58.245 |
| | TiO2 | 609.8 |
| | SiO2 | 490.8 |
| | Σ | 1446.9 |

### PAGE INTENTIONALLY LEFT BLANK

TABLE 2
SiO₂/Ag

| | | Design |
|---|---|---|
| | | SiO2/Ag |
| Layer | Material | d phy |
| Substrate | Glass | [nm] |
| 1 | SiO2 | 115.8 |
| 2 | Ag | 21.3 |
| 3 | SiO2 | 115.8 |
| 4 | Ag | 21.3 |
| 5 | SiO2 | 115.8 |
| 6 | Ag | 21.3 |
| 7 | SiO2 | 115.8 |
| 8 | Ag | 21.3 |
| 9 | SiO2 | 115.8 |

TABLE 3
Si₃N₄/Ag

| | | Design |
|---|---|---|
| | | Si3N4/Ag |
| Layer | Material | d phy |
| Substrate | Glass | [nm] |
| 1 | Si3N4 | 73.6 |
| 2 | Ag | 21.3 |
| 3 | Si3N4 | 73.6 |
| 4 | Ag | 21.3 |
| 5 | Si3N4 | 73.6 |
| 6 | Ag | 21.3 |
| 7 | Si3N4 | 73.6 |
| 8 | Ag | 21.3 |
| 9 | Si3N4 | 73.6 |

TABLE 4
NIR-blocker 1-2

| | | Design 1 | Design 2 |
|---|---|---|---|
| Layer | Material | d phy | d phy |
| Substrate | Glass | [nm] | [nm] |
| 1 | AZO/GaZO | 23.3 | 45.8 |
| 2 | Ag | 16.6 | 15.0 |
| 3 | AZO/GaZO | 66.9 | 79.6 |
| 4 | Ag | 19.3 | 24.0 |
| 5 | AZO/GaZO | 70.5 | 71.2 |
| 6 | Ag | 20.8 | 22.4 |
| 7 | AZO/GaZO | 72.5 | 81.5 |
| 8 | Ag | 20.8 | 22.9 |
| 9 | AZO/GaZO | 39.7 | 39.1 |
| Σ | d Agx4 | 77.5 | 84.3 |
| Σ | d AZO/GaZO | 272.9 | 317.1 |
| | x5 | | |
| Σ | total d | 350.4 | 401.5 |

TABLE 5
NIR-blocker 3

| | | Design 3 |
|---|---|---|
| Layer | Material | d phy |
| Substrate | Glass | [nm] |
| 1 | TiO2 | 21.146 |
| 2 | ZnO | 6.0 |
| 3 | Ag | 21.1 |
| 4 | TiO2 | 55.4 |
| 5 | ZnO | 6 |
| 6 | Ag | 20.0 |
| 7 | TiO2 | 52.2 |
| 8 | ZnO | 6 |
| 9 | Ag | 23.4 |
| 10 | TiO2 | 28.2 |

TABLE 6
NIR-blocker 4-7

| | | Design | Design | Design | Design |
|---|---|---|---|---|---|
| | | 4 | 5 | 6 | 7 |
| Layer | Material | d phy | d phy | d phy | d phy |
| Substrate | Glass | [nm] | [nm] | [nm] | [nm] |
| 1 | ZnO | 34.1 | 35.2 | 37.8 | 30.4 |
| 2 | Ag | 17.4 | 18.0 | 18.0 | 19.7 |
| 3 | ZnO | 73.0 | 74.5 | 76.7 | 74.7 |
| 4 | Ag | 20.2 | 18.1 | 18.0 | 18.7 |
| 5 | ZnO | 67.8 | 68.9 | 70.2 | 72.1 |
| 6 | Ag | 19.0 | 20.8 | 21.4 | 22.0 |
| 7 | ZnO | 58.0 | 74.2 | 73.3 | 32.8 |
| 8 | Ag | 11.5 | 18.9 | 18.6 | — |
| 9 | ZnO | 10.0 | 35.7 | 76.3 | — |
| 10 | Ag | — | — | 18.0 | — |
| 11 | ZnO | — | — | 38.3 | — |

TABLE 7
NIR-blocker (+AR) 10-12

| | | Design | Design | Design |
|---|---|---|---|---|
| | | 10 | 11 | 12 |
| Layer | Material | d phy | d phy | d phy |
| Substrate | Glass | nm | nm | nm |
| 1 | Ta2O5 | 121.1 | 126.9 | 89.2 |
| 2 | SiO2 | 77.7 | 61.4 | 121.2 |
| 3 | ZnO | 55.1 | 56.6 | 79.3 |
| 4 | Ag | 12.0 | 12.0 | 50.4 |
| 5 | ZnO | 79.9 | 80.1 | 12.0 |
| 6 | Ag | 18.4 | 18.4 | 78.9 |
| 7 | ZnO | 73.0 | 75.0 | 18.4 |
| 8 | Ag | 23.2 | 23.2 | 77.5 |
| 9 | ZnO | 69.7 | 69.7 | 23.2 |
| 10 | Ag | 15.0 | 15.0 | 69.2 |
| 11 | ZnO | 131.8 | 135.1 | 15.0 |
| 12 | Ta2O5 | 90.2 | 94.1 | 137.3 |
| 13 | SiO2 | 90.4 | 67.7 | 91.4 |
| 14 | Ta2O5 | 118.6 | 140.4 | 83.7 |
| 15 | SiO2 | 65.5 | 63.6 | 121.7 |
| 16 | Ta2O5 | 150.6 | 125.1 | 63.1 |
| 17 | SiO2 | 201.0 | 87.9 | 143.5 |
| 18 | Ta2O5 | 53.7 | 90.4 | 63.4 |
| 19 | SiO2 | — | 91.4 | 127.6 |
| 20 | Ta2O5 | — | 128.4 | 81.1 |
| 21 | SiO2 | — | 195.6 | 131.9 |
| 22 | Ta2O5 | — | 56.5 | 18.1 |
| 23 | SiO2 | — | — | 174.0 |
| 24 | Ta2O5 | — | — | 67.0 |
| 25 | SiO2 | — | — | 152.6 |
| 26 | Ta2O5 | — | — | 177.9 |
| 27 | SiO2 | — | — | 78.9 |
| Σ | d Ag 4x | 68.6 | 68.6 | 68.6 |
| Σ | d ZnO | 277.7 | 281.4 | 276.0 |
| | (AZO/GaZO) | | | |
| Σ | d Ta2O5 | 609.8 | 768.1 | 812.8 |
| Σ | d SiO2 | 490.8 | 696.3 | 1190.0 |
| Σ | d total | 1446.9 | 1814.4 | 2347.4 |

TABLE 8
Process parameters⁺

| Layer-Material | Process | Process Parameters |
|---|---|---|
| ZnOₓ, ZnOₓ:Al | React. RF or DC- | O₂ and inert gas (Ar), p: 1 × 10⁻⁴ − 9 × 10⁻³ mbar, |
| | pulsed or DC or AC- | 0.2-20 kW/cathode⁺⁺; |
| | MF sputter | |
| Ag | DC-pulsed or DC | Inert gas (Ar) only, p: 1 × 10⁻⁴ − 9 × 10⁻³ mbar, |
| | | 0.2-20 kW/cathode⁺⁺; |
| Ti, or Ti O_{sub}, or NiCr, | React. or not- | Inert gas (Ar) + O₂ facult. (e.g. metallic) |
| or NiCrO_{sub} | reactive RF- or DC- | targets, p: 1 × 10⁻⁴ − 9 × 10⁻³ mbar, |
| | pulsed or DC or AC- | 0.2-20 kW/cathode⁺⁺; |
| | MF sputter | |
| Ta₂O₅ | React. RF- or DC- | O₂ and inert gas (Ar), p: 1 × 10⁻⁴ − 9 × 10⁻³ mbar, |
| | pulsed or DC or AC- | 1-20 kW/cathode⁺⁺; |
| | MF sputter. | |
| SiOₓ | React. RF- or DC- | O₂ and inert gas (Ar), p: 1 × 10⁻⁴ − 9 × 10⁻³ mbar, |
| | pulsed or DC or AC- | 1-20 kW/cathode⁺⁺; |
| | MF sputter. | |

⁺All processes for test glasses and filters have been produced on a commercially available Evatec vacuum equipment of the type: CLN 200 BPM, MSP, Solaris and/or LLS;
⁺⁺Planar cathodes with target dimensions circular 200-450 mm or rectangular 1 × b = 35 − 85 × 13 cm, were used for all experiments, rotatable cathode targets can be used as well.

### Reference Numbers

1′ seed layer
1 ZnOₓ, AZO, GaZO
2 Ag
3 ZnOₓ, AZO, GaZO
4 Ag
ZnOₓ, AZO, GaZO
6 TiO_{X}, ZnOₓ, SnOₓ, NiCrOₓ
7 dielectric stack
10 TiO₂, Ta₂O₅, ZrO₂, Si₃N₄
11 AR-stack (dielectric)
12 NIR blocking layer stack
13 further AR-stack (dielectric)
14 SiO₂ layer or stack of SiO₂/high index/ . . . /SiO₂ layers
20 fingerprint identification system type I
21 cover plate
22 front plate
23 back plate
24 LED module, e.g. OLED
25 transparent spacer with low RI
26 lens
27 collimator/pinhole array/optical waveguide
28 sensor or sensor array
29 separate light source
30 NIR-filter stack
31 separate filter with NIR-filter on one side
32 controller unit
33 absorption layer
34 collimator through hole
35 boundary of the optical path
36 finger
37 fingerprint area
40 fingerprint identification system type II

What is claimed is:

1. A biometric authentication system comprising:
a translucent protective plate having an authentication region on a front face of the protective plate, and a reverse side forming the second face of the plate, essentially in parallel to the front face;
a light emitting source to illuminate an object pressed against or being in touch with the authentication region;
a sensor arranged at the reverse side or in a distance from the reverse side;
an optical path from the authentication region to the sensor;
an optical filter within the optical path;
whereat the optical filter is a layered near infrared (NIR) filter comprising
at least one of an inner ZnOₓ and/or inner TiOₓ layer at a substrate side;
followed by a multitude of silver layers, each silver layer being separated from each neighbouring silver layer by at least one further metal oxide layer consisting of a further ZnOₓ and/or a further TiOₓ layer;
at least one of an outer ZnOₓ layer, an outer TiOₓ layer, and/or a blocking layer deposited on the outermost silver layer.

2. The system according to claim 1, wherein the blocking layer consists of at least one of TiOₓ, ZnOₓ, SnOₓ, CryOₓ and/or NiCrOₓ.

3. The system according to claim 1, wherein a metal interface layer consisting of a metal corresponding to the respective metal of a metal oxide layer is provided between at least one neighboring silver layer and the metal oxide layer.

4. The system according to claim 1, wherein the metal-oxide layers are substoichiometric at least at the silver side or sides.

5. The system according to claim 1, wherein at least one ZnOₓ layer is an aluminum doped ZnOₓ:Al (AZO) layer, or a Galium doped ZnOₓ:Ga (GaZO) layer.

6. The system according to claim 1, wherein an antireflective (AR) stack of alternating high and low refractive layers is deposited on one of the outer ZnOₓ layer, the outer TiOₓ layer, or the blocking layer.

7. The system according to claim 6, wherein the NIR-stack comprises at least 4 layers, for instance 16 to 32 layers.

8. The system according to claim 1, wherein a metallic or a semi-conductive seed layer is provided at the substrate surface.

9. The system according to claim 1, wherein a further AR-stack of alternating high and low refractive layers is deposited between the substrate or the seed layer and the inner ZnOₓ or inner TiOₓ layer.

10. The system according to claim 9, wherein the further AR-stack comprises at least 2 alternating layers.

11. The system according to claim 10, wherein the further AR-stack is also a UV-light damping or blocking stack.

12. The system according to claim 1, wherein a SiO₂ layer, or a stack of alternating SiO₂ and at least one high index layer consisting of high index material is sandwiched between two further metal oxide layers (3), whereat each of the two further metal oxide layers is in direct contact to the or to a SiO₂ layer, and is adjacent to a respective silver layer with its side facing away from the sandwiched SiO₂ layer(s).

13. The system according to claim 12, wherein the high index material is Ta₂O₅, TiO₂, Nb₂O₅, HfO₂, ZrO₂ or Si₃N₄.

14. The system according to claim 12, wherein the sandwiched stack is a three layer stack consisting of two SiO₂ layers and a high index layer sandwiched between.

15. The system according to claim 1, wherein the light emitting source is a planar light source arranged below the authentication region.

16. The system according to claim 1, wherein the light emitting source is a separate light source arranged below the authentication region.

17. The system according to claim 1, wherein the filter has a wavelength shift of smaller 5% of the NIR edge when using light in an angle of 600 to the surface normal instead of a 0°-degree measurement.

18. The system according to claim 1, wherein the optical path comprises a lens or a mirror.

19. The system according to claim 1, wherein the optical path comprises a collimator.

20. The system according to claim 1, wherein the optical path does not comprise one of a lens, a mirror or a collimator.

21. A touch screen comprising a system according to claim 1.

22. An electronic device comprising a touch screen according to claim 21.

23. The electronic device according to claim 22 being a cell phone, a touch pad, a computer, or another input/output device.
